(19) United States
(12) Patent Application Publication
(10) Pub. No.: US 2021/0349592 A1
(43) Pub. Date: Nov. 11, 2021

(54) METHOD FOR OPERATING A HUMAN-MACHINE INTERFACE, AND HUMAN-MACHINE INTERFACE

(71) Applicant: BCS AUTOMOTIVE INTERFACE SOLUTIONS GMBH, Radolfzell (DE)

(72) Inventors: SÖREN LEMCKE, Gundholzen-Gaienhofen (DE); NIKOLAJ POMYTKIN, Konstanz (DE); TIMO SCHUBERT, Bodman-Ludwigshafen (DE); UWE CLASS, Schechingen (DE)

(21) Appl. No.: 16/479,632

(22) PCT Filed: May 23, 2017
(86) PCT No.: PCT/EP2017/062365

§ 371 Date: Jul. 22, 2019

(30) Foreign Application Priority Data
Jan. 27, 2017 (DE) 10 2017 101 669.4

(51) Int. Cl. G06F 3/0488; G06F 3/041; G06F 3/01; G06F 3/0484; B60K 35/00; B60K 37/06

(52) U.S. Cl. CPC G06F 3/0488; B60K 2370/166; G06F 3/016; G06F 3/0484; B60K 35/00; B60K 37/06; G06F 2203/04104; G06F 2203/04808; B60K 2370/1434; B60K 2370/158; B60K 2370/148; B60K 2370/1472; B60K 2370/782; B60K 2370/794; B60K 2370/771; B60K 2370/791; B60K 2370/164; G06F 3/041

(57) ABSTRACT

A method for operating a human machine interface for a vehicle includes a vehicle component, a control unit and a touch-sensitive surface that is provided in the vehicle component. The method includes recognizing a touch on an arbitrary contact point of the touch-sensitive surface, and assigning to the contact point a button, by means of which an input is possible, wherein a function is assigned to the button. Moreover, a human machine interface is shown.

### RELATED APPLICATIONS

This application corresponds to PCT/EP2017/062365, filed May 23, 2017, which claims the benefit of German Application No. 10 2017 101 669.4 filed Jan. 27, 2017, the subject matter of which are incorporated herein by reference in their entirety.

### FIELD OF THE DISCLOSURE

The disclosure relates to a method for operating a human machine interface for a vehicle as well as a human machine interface for a vehicle.

### BACKGROUND

Human machine interfaces for vehicles comprising touch-sensitive surfaces are known. In such interfaces, buttons on a touch-sensitive surface are normally configured by a control unit.

Within the scope of this disclosure, a button is understood to be mean an area on the touch-sensitive surface that acts as a push button or slider. The button can be actuated in order to interact with the human machine interface. To this end, actuation can be carried out by touching, swiping or increasing pressure on the touch-sensitive surface. If an area of the touch-sensitive surface is touched (or otherwise actuated), the control unit checks whether this touch has taken place in the area of one of the buttons. If this is the case, the corresponding button is considered to be actuated. Such buttons are well known from touch displays, for example from smartphones or tablets.

Normally, the buttons are located at predetermined areas on the touch-sensitive surface and are shown, for example, by an appropriate representation on the display itself in the case of a touch-sensitive display.

Increased attention is needed for operating such a human machine interface as the user has to touch a button represented only visually with his finger in order to initiate a certain function. However, this is disadvantageous in human machine interfaces in vehicles as the user, usually the driver, should be distracted as little as possible from the road.

### SUMMARY

Thus, there is a need to provide a method for operating a human machine interface for a vehicle as well as a human machine interface for a vehicle, wherein the operation of said human machine interface requires less attention.

The object is solved by a method for operating a human machine interface for a vehicle, comprising a vehicle component, a control unit and a touch-sensitive surface that is provided on the vehicle component, comprising the following steps:
a) a touch on an arbitrary contact point of the touch-sensitive surface is recognized,
b) a button, by means of which an input is possible, is then assigned to the contact point, wherein a function is assigned to the button.

To this end, the control unit is connected to the touch-sensitive surface. The recognition of a touch can occur through the control unit or through a controller of the touch-sensitive surface itself. The assignment of the button to the contact point occurs through the control unit, wherein the button can be operated through renewed touching, increasing pressure against the touch-sensitive surface or dragging/swiping. In particular, the method is then executed if the touch-sensitive surface is touched again after a certain period without being touched.

The disclosure moves away from the principle of the prior art that fixed, predetermined areas of the touch-sensitive surface are used as specified buttons which have to be touched by the user with his finger in order to be operated. In contrast, the fundamental idea of the disclosure is that the user can now touch the touch-sensitive surface on an arbitrary contact point and a button can then be allocated to this point. The buttons are therefore not fixed in position and their position is not fixedly predetermined. Consequently, the user does not have to pay attention to touching the position of the button, but rather the entire touch-sensitive surface is available to the user.

Figuratively speaking, the attention required is diminished as the finger of the user does not search for the button, but rather the button searches for the finger.

The button can be actuated in the usual way, for example, through renewed touching, increasing the pressure (pressing of the finger on the touch-sensitive surface more strongly) or dragging and swiping.

Preferably, several touches, in particular from several fingers, are recognized on several contact points of the touch-sensitive surface, wherein a button is each assigned to at least two contact points. The touches occur simultaneously. In this way, an ergonomic operation of the human machine interface is possible using several fingers irrespective of the hand size.

For example, the function(s) is or are displayed on an output screen spatially separated from the touch-sensitive surface and/or the vehicle component so that the user can easily read the functions of the buttons at the contact points, thus the buttons under his fingers. To this end, the display of the functions in the case of several contact points can occur in the order of the buttons on the touch-sensitive surface in order to simplify for the user the assignment of functions to the buttons under his fingers.

The output screen is, for example, a screen in the dashboard and/or the screen of a heads-up display so that the user only has to stop looking at the road for a brief moment in order to operate the human machine interface.

A haptic and/or optical feedback can occur when actuating the button or one of the buttons in order to further reduce the operability and thus the attention required for operation. An optical or visual feedback can be generated, for example, by the output screen or by at least an optical element on the touch-sensitive screen. A haptic feedback can be provided, for example, by a vibration motor, a pressure resistance device, similar to physical push buttons, or by an ultrasonic source.

In an embodiment of the disclosure, the position and/or the function of the button or the buttons are displayed by at least one optical element on the touch-sensitive surface. The optical element can be a screen or several LEDs. In this way, the operability and thus the attention required for operation can be reduced further.

For example, it is recognized with which finger the touch-sensitive surface is touched and the corresponding finger of a hand is then allocated to the contact point. This is particularly possible in the case of touches at several contact points by counting the contact points and/or analyzing the spacings of the contact points to each other. In this way, information about the user can be obtained and/or further functions are made possible.

Preferably, the button that is assigned to the contact point of a predetermined finger, in particular the thumb, always has the same function. As a result, the user knows that he can always execute the same function by actuating the touch-sensitive surface with this specific finger, and so the use is simplified further. For example, the user becomes accustomed to the fact that it is possible to always return to the main menu by means of the thumb.

For example, it is recognized whether the finger of a left or a right hand touches the touch-sensitive surface, wherein at least one function is allocated depending on whether the touch-sensitive surface is operated by a right or a left hand. The recognition occurs, for example, by using the position of the thumb because the operating direction is known, i.e. the side of the touch-sensitive surface on which the heel of the hand rests.

The information about with which hand the touch-sensitive surface is operated allows conclusions to be drawn on the user who then can be offered functions customized for him. For example, a touch-sensitive surface that is located on a center console in a vehicle for right-hand traffic is operated by the driver with his right hand and by the front passenger with his left hand. By recognizing the hand, it is therefore possible to differentiate between the driver and the front passenger so that the driver can be offered different functions as the front passenger.

For example, the function assigned to the button is preselected or the functions assigned to the buttons are preselected by the user, in particular by a voice control, a gesture control and/or a mechanical input element spatially separated from the touch-sensitive surface. Thus, the human machine interface can be adapted to the requirements of the driver by the driver.

The input element can be, for example, a rotary switch in the center console and/or physical buttons in the steering wheel.

Moreover, the object is solved by a human machine interface for a vehicle, said human machine interface is configured in particular for executing the method according to the disclosure, comprising a vehicle component, a control unit and a touch-sensitive surface that is provided on the vehicle component. During operation of the human machine interface, at least one button is provided on the touch-sensitive surface, the position of said button being determined by the control unit in such a way that, in the case of a touch of the touch-sensitive surface on an arbitrary contact point, the position of the button is set to the contact point that has been touched by the control unit.

If a position is not allocated a button, this button is inactive. The buttons are then set if the touch-sensitive surface is touched again after a certain period without being touched. As a result, the attention needed for operation is reduced.

Preferably, several buttons can be provided at the same time in the case of several touches on several contact points, wherein each button is located at each one of the contact points that have been touched. As a result, the human machine interface can also be operated using several fingers simultaneously.

For example, the human machine interface comprises an output screen that is located spatially separated from touch-sensitive surface and/or the vehicle component, wherein the function of said at least one button is displayed on the output screen. In the case of several buttons, the order of the functions on the output screen corresponds to the order of the contact points on the touch-sensitive surface. The output screen can have a screen in the dashboard and/or a screen of a head-up display (HUD).

In order to select functions, said at least one button is operable by renewed touch, increasing the pressure and/or shifting the contact point.

In an embodiment of the disclosure, the touch-sensitive surface and/or the vehicle component comprises a mechanical feedback element for haptic feedback, in particular a vibration motor, a pressure resistance device and/or an ultrasonic source. To this end, the pressure resistance is executed in such a way that it generates a pressure point like in the case of a physical push button.

In an embodiment, at least one optical element is provided on the touch-sensitive surface for displaying the position and/or function of said at least one button in order to simplify the operation further. A screen, a LED matrix or LEDs are, for example, possible optical elements.

For example, the vehicle component is a steering wheel, a seat, a control stick, a door trim, an armrest, a part of a center console, a part of a dashboard and/or a part of an overhead trim, thereby enabling the touch-sensitive surface to be reached conveniently by the user, in particular the driver.

### DESCRIPTION OF THE DRAWINGS

Additional features and advantages of the disclosure are found in the following description as well as the attached drawings to which reference is made. In the drawings:

FIG. 1a shows a perspective view of a cockpit of a vehicle that is provided with a human machine interface according to the disclosure,

FIG. 1b shows a schematic sectional view of part of the cockpit according to FIG. 1a in the area of the touch-sensitive surface,

FIGS. 2a to 2d as well as 3a to 3d show illustrations of the method according to the disclosure in different steps and situations, and

FIGS. 4a to 4c show a further illustration of different steps during the operation of the human machine interface according to the disclosure.

### DETAILED DESCRIPTION

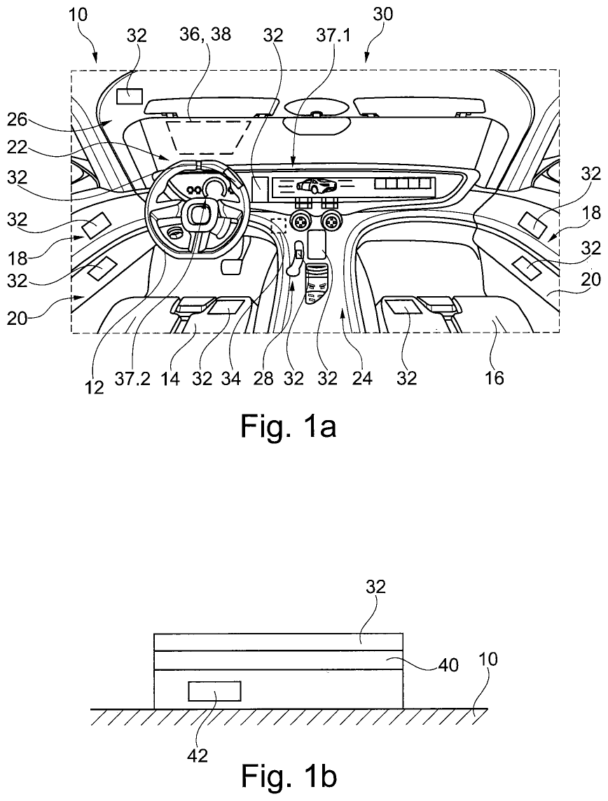

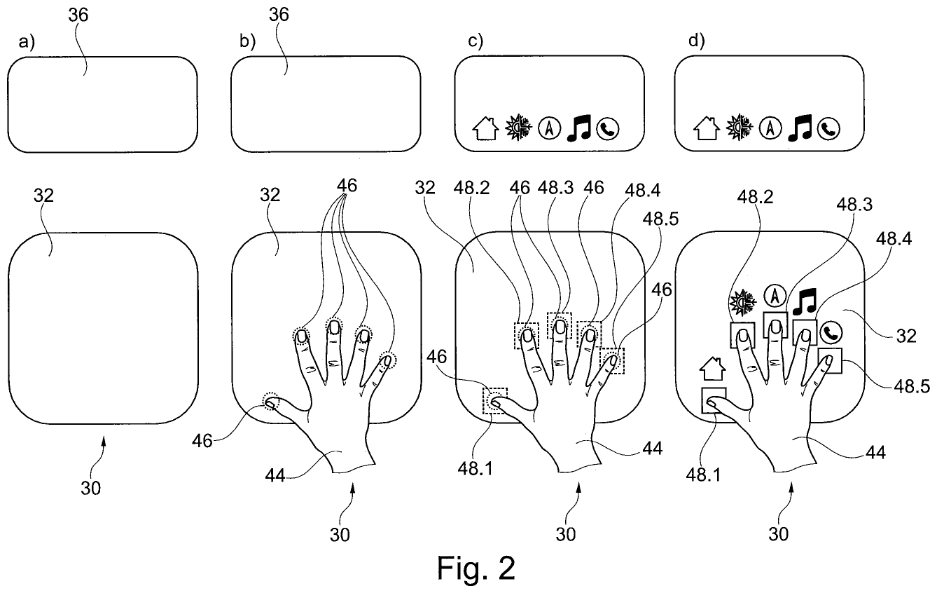

In FIG. 1, the cockpit of a vehicle is shown.

The cockpit comprises different vehicle components 10 in the conventional manner, such as a steering wheel 12, a driver's seat 14, a front passenger's seat 16, door trims 18, armrests 20, a dashboard 22, a center console 24 and/or overhead trim 26.

Furthermore, a control stick 28 may be provided in the cockpit.

Moreover, the cockpit features a human machine interface 30 that comprises several touch-sensitive surfaces 32, a control unit 34 and several output screens 36 in the shown embodiment.

The control unit 34 is connected to the output screens 36 and the touch-sensitive surfaces 32 by information technology.

In FIG. 1, two screens 37.1, 37.2 are provided in the dashboard 22 as output screens 36 and a screen of a head-up display 38 (HUD) also serves as an output screen 36.

In the shown embodiment, the human machine interface 30 comprises eleven touch-sensitive surfaces 32 on different vehicle components 10. The vehicle components 10, on which the touch-sensitive surfaces 32 are provided, are then part of the human machine interface 30.

However, the number of touch-sensitive surfaces 32 is only to be seen as an example. The human machine interface 30 can also be designed with a touch-sensitive surface 32 on one of the vehicle components 10 or any other number of touch-sensitive surfaces 32.

In the shown embodiment, the touch-sensitive surfaces 32 are located on each one of the door trims 18 of the driver's door or the front passenger's door or on the corresponding armrests 20.

A touch-sensitive surface 32 is also located on the overhead trim 26 in the driver's area.

An additional touch-sensitive surface 32 is provided on the steering wheel 12, wherein the touch-sensitive surface 32 is shown on the front of the steering wheel 12 in FIG. 1. It is also possible and advantageous if the touch-sensitive surface 32 extends on the rear of the steering wheel 12 or is only provided there.

Furthermore, one touch-sensitive surface 32 is provided in the dashboard 22 and one in the center console 24.

Touch-sensitive surfaces 32 are also located on the driver's seat 14 and the front passenger's seat 16 and serve in particular the purpose of adjusting the seat. As an illustration, these touch-sensitive surfaces 32 are shown on the upper side of the seats 14, 16. However, these can also be located on the side of the seats 14, 16 at the usual positions for seat adjustment devices.

At least one touch-sensitive surface 32 is also provided on the control stick 28. For example, the touch-sensitive surface 32 on the control stick 28 is divided into different areas that are provided at locations on the control stick 28 against which the user's fingertips rest.

In FIG. 1b, a touch-sensitive surface 32 on a vehicle component 10 is shown in section.

The touch-sensitive surface 32 is not attached directly to the vehicle component 10 in the shown embodiment, but rather an optical element 40, in this case an additional screen, is provided under the touch-sensitive surface 32. The optical element 40 can, however, also be a LED matrix or individual LEDs.

The screen and the touch-sensitive surfaces 32 form together a touch-sensitive touch display, such as is well-known from smartphones or tablets. It is, of course, also conceivable that the order of touch-sensitive surfaces 32 and the optical element 40 is exchanged and/or a protective layer is provided in addition on the exterior.

Moreover, a mechanical feedback element 42 is provided between the touch-sensitive surface 32 and the vehicle component 10. In the shown embodiment, there is in this case a vibration motor that can cause the touch-sensitive surface 32 to vibrate.

It is however also conceivable that the mechanical feedback element 42 is a pressure resistance device, such as is well-known from physical push buttons (e.g. on a keyboard). The pressure resistance device can generate a specific pressure point by means of a mechanical counterforce in order to produce a haptic feedback when pressing the touch-sensitive surface 32.

However, it is also conceivable that the mechanical feedback element 42 is an ultrasonic source that emits ultrasonic waves in the direction of a user's fingers to produce a haptic feedback when operating the touch-sensitive surface 32.

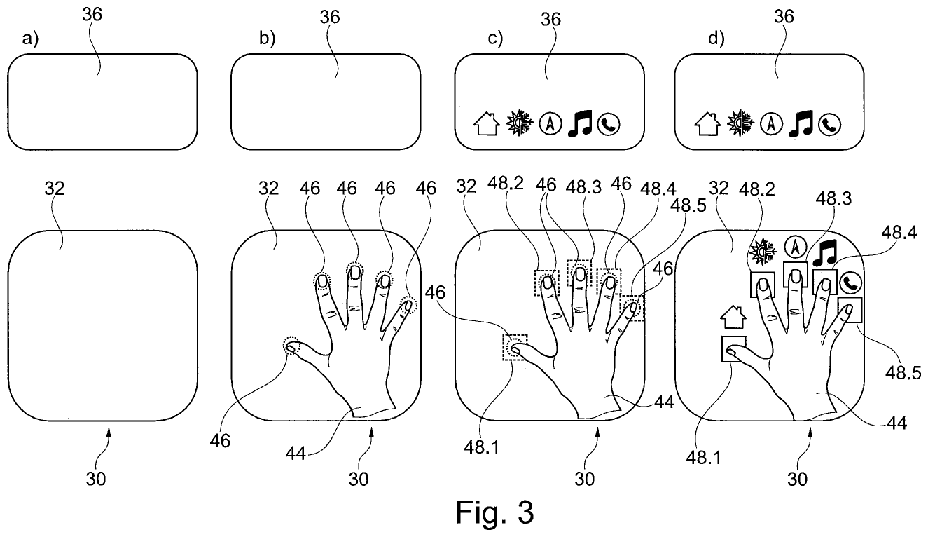

In FIGS. 2, 3, and 4, one of the touch-sensitive surfaces 32 (bottom) as well as part of the display of an output screen 36 (top) are shown schematically for the purpose of explaining the method.

Initially, the touch-sensitive surface 32 is not touched and no information is also displayed on the output screen 36 (FIG. 2a).

If the user places his hand 44 on the touch-sensitive surface 32, as shown in FIG. 2b, he touches the touch-sensitive surface 32 with his fingers at five different contact points 46 simultaneously.

The user can place his hand on any location on the touch-sensitive surface 32 or his fingers can touch the touch-sensitive surface 32 on any location without thus interfering with the method.

The touch of the fingers on the contact points 46 is recognized by the control unit 34 and these contact points 46 are then each assigned a button 48.1, 48.2, 48.3, 48.4, 48.5 (grouped together in the following under the reference sign 48). In addition, the position (for example the center) of one of the buttons 48 is set to one of the contact points 46.

It is however also conceivable that the touch is executed by a controller of the touch-sensitive surface 32 and that the result is sent to the control unit 34 so that control unit 34 assigns the buttons 48 and sets their positions.

The buttons 48 are thus assigned to individual contact points 46 and comprise the respective contact point 46. In short, buttons 48 that are assigned to each other and contact points 46 are located at the same position on the touch-sensitive surface 32.

The buttons 48 are designed larger than the contact points 46 in this regard so that the contact points 46 are completely enclosed. Moreover, the buttons 48 can have a round, in particular circular, or a quadratic contour.

Moreover, when fingers are placed on the touch-sensitive surface 32, the control unit 34 can recognize which contact point 46 must correspond to which finger of a hand and assigns the corresponding finger to the contact points 46 and the assigned buttons 48 accordingly.

The finger recognition occurs, for example, by means of an analysis of the position of the contact points 46 relative to each other as this is largely predetermined by human anatomy.

Furthermore, a function is assigned to the buttons 48 by the control unit 34, said function is connected to the operation of the corresponding vehicle component 10 or the general infotainment system of the vehicle.

This function is displayed in the output screen 36, for example as a symbol or icon.

In the shown embodiment, the thumb is assigned to the button 48.1 in FIG. 2c and allocated the return to main menu as its function. This function is symbolized on the output screen 36 by a small house.

In the same way, the index finger and the “air conditioning system” function are assigned to the button 48.2; the middle finger and the “navigation system” function are assigned to the button 48.3; the ring finger and the “entertainment” function are assigned to the button 48.4 and the little finger and the function “telephony” are assigned to the button 48.5.

The user can preselect which functions are assigned to the individual buttons 48. The user can also preselect complete function groups or function menus.

The preselection can occur by means of a voice control, a gesture control and/or a mechanical input element spatially separated from the touch-sensitive surface (not shown). The input element can be, for example, a rotary switch in the center console and/or physical buttons, among other things, on the steering wheel.

All these functions are displayed on the output screen 36 by symbols. In this regard, the order of displayed functions, thus the symbols, corresponds to the order of the fingers on the touch-sensitive surface 32.

At the same time, the symbol of the corresponding function can also be displayed via the optical element 40 above each finger, as shown in FIG. 2d), in order to indicate the functions of the buttons 48 on the touch-sensitive surface 32 itself.

Moreover, the buttons 48 can be displayed on the optical element 40 itself, for example, as a frame or highlighted area. For the sake of clarity, the display of the contact points 46 has been forgone in FIG. 2d).

The user can now select the desired function by actuating the corresponding button 48.

If the user completely removes his hand again from the touch sensitive surface 32 for a specific, normally briefly selected period, the buttons 48 are deactivated (FIG. 3a).

If the user places his hand afterwards once again on the touch-sensitive surface 32 (FIG. 3b), this usually occurs in another position as before and the contact points 46 are at another position. This is however not a problem as the position of the buttons 48 can simply be set to the new contact points 46 by the control unit 34 in this case (FIGS. 3c, d) and indeed in the same way as described previously.

In FIGS. 3c and 3d, it is easy to recognize that the buttons 48 may be assigned the same functions, but the positions of the buttons 48 have changed considerably.

Figuratively speaking, it is also possible to say that the buttons 48 have searched for their assigned fingers again so that the user of the human machine interface 30 does not have to search himself for the buttons 48. It suffices completely that he touches the touch-sensitive surface 32 at any location with his fingers.

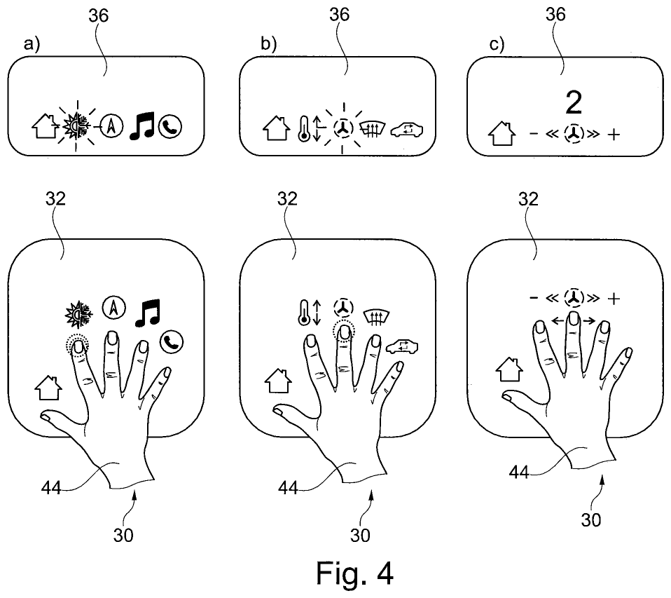

After the user has placed his hand on the touch-sensitive surface 32 and the appropriate buttons 48 have been assigned along with the functions by the control unit 32 (FIGS. 2d and 3d), the user can now select the desired functions. This is shown in FIGS. 4a to 4c, wherein FIG. 4a corresponds to FIG. 2d and the corresponding situation.

In the embodiment shown in FIG. 4, the user wants to turn up the ventilation. To this end, he has to initially access the menu for controlling the air conditioning system that can be reached through the “air conditioning system” function. This function is the assigned to the button 48.2 that is located under his index finger.

The user thus actuates the button 48.2. This can be carried out, for example, by the user lifting his index finger only briefly and placing it again on the touch-sensitive surface 32 so that the button 48 is touched anew.

The position of this renewed touch is then assessed by the control unit 34 and assigned to the button 48.2 so that the control unit 34 considers the button 48.2 as being actuated and executes the corresponding “air conditioning system” function. In this case, there is then a change to the menu for controlling the air conditioning system.

This can be confirmed by a lighting up of the symbol of the climate control on the output screen 36, thus providing the user with a visual feedback.

When the button is actuated, the mechanical feedback element 42, in this case the vibration motor, is briefly activated so that the user receives a haptic feedback that he has just actuated the button 48.2.

However, it is also conceivable that the actuation has to occur by increasing pressure, i.e. that the user increases the pressure on the touch-sensitive surface 32 in the area of the button 48.2 with his index finger. This increase in pressure can be recognized, for example, through the expansion of the contact point 46 in the area of the index finger. However, there are also other possible ways of recognizing an increase in pressure.

The menu for controlling the air condition system, to which the user has just switched, is shown in FIG. 3b). The functions of the buttons 48.2 to 48.5 that are assigned to the index, middle, ring and little fingers, have now changed and are now “temperature setting”, “fan settings”, “rear window heating” and “recirculating air”. Consequently, the symbols in the output screen 36 and if necessary the symbols on the optical element 40 have also changed.

The button 48.1 that is assigned to the thumb continues to have the same function, namely the return to main menu so that this symbol has not changed. In this way, it is possible to ensure that the user can always return to the main menu by actuating the button 48.1 with his thumb or can execute another specific function. Of course, this can apply equally to the other fingers.

In FIG. 3b, the user actuates however the button 48.3 by means of his middle finger in order to select the fan propeller control so that he can set the ventilation.

In doing so, the user receives once again an optical feedback or feedback via the output screen 36 by the corresponding symbol lighting up briefly, in this case the fan propeller symbol. A haptic feedback is also generated once again by the vibration motor.

The user then accesses the menu according to FIG. 3c, by means of which it is possible to set the speed of the fan propeller. To this end, the button 48.3 can be designed, for example, as a slider that the user can actuate by swiping or dragging his middle finger to the left or right, i.e. by shifting the contact point 46.

Alternatively or additionally, functions which increase or decrease the speed of the fan propeller incrementally can be assigned to the buttons 48.2 and 48.4 of the index or ring finger. This is displayed with a minus or plus symbol both on the output screen 36 and on the optical element 40.

In addition, the current speed setting can be indicated on the output screen 36. In this case, the speed setting is “2”.

The user thus achieves his goal, namely changing the power of the ventilation of the air conditioning system. To this end, he does not have to feel for a push button or find a specific button with his finger as the buttons 48 have each been set by the control unit 34 to the contact points 46 of the fingers of his hand.

The user received an optical check or feedback on his action completely through the output screen 36 that is on the dashboard 22 or in the head-up display 38 so that he only has to turn his gaze away from the road for a brief moment. As a result, he can execute the desired task without any great loss of attention.

Whether a right or a left hand rests on the touch-sensitive surface 32 can also be determined by the control unit 34 based on the positions of the contact points 46 to each other.

For example, this is necessary in order to always be able to assign that function to the fingers, said function that the user associates with the corresponding finger. For example, to ensure that the user always returns to the main menu by actuating the button underneath his thumb.

The information whether a left or a right hand rests on the touch-sensitive surface 32 can also be used to select the functions that are assigned to the buttons 48.

If, for example, the touch-sensitive surface 32 is installed on the center console 24 in a vehicle that is designed for right-hand traffic, the driver operates the touch-sensitive surface 32 with his right hand, however, the front passenger only with his left hand.

Based on the hand 44 that is used, the control unit 34 can thus recognize whether the driver or the front passenger is operating the touch-sensitive surface 32.

As a result, different functions for the driver and front passenger can be then assigned to the buttons 48. For example, the front passenger can only change the climatic zone for the front passenger's seat.

In the shown embodiment, the human machine interface 30 is used to operate the general infotainment system of the vehicle together with the climate control, the navigation system, telephony and additional functions. It is however conceivable that only such functions are selectable by means of the human machine interface 30, said functions being customized to the corresponding vehicle component 10 on which the touch-sensitive surface 32 is located.

By means of a touch-sensitive surface 32 that is provided on one of the seats 14, 16, only the position of this seat 14, 16 can be set for example. In this case, the touch-sensitive surface 32 or the human machine interface 30 replaces the usual physical buttons for adjusting the seat.

It is also conceivable that the user starts the operation of the vehicle by means of one of the touch-sensitive surfaces 32 and then changes to a mechanical input element separate from the touch-sensitive surface 32 for the purpose of continuing the operation or vice versa.

In addition, it is also conceivable that another menu logic arises through the actuation of two actuation elements 48 simultaneously and/or through the actuation of one actuation element 48 and the simultaneous actuation or touch of the separate input element.

1-20. (canceled)

21. Method for operating a human machine interface for a vehicle, comprising a vehicle component, a control unit and a touch-sensitive surface that is provided on the vehicle component, comprising the following steps:
c) a touch on an arbitrary contact point of the touch-sensitive surface is recognized,
d) a button, by means of which an input is possible, is then assigned to the contact point,
wherein a function is assigned to the button.

22. Method according to claim 21, wherein several simultaneous touches on several contact points of the touch-sensitive surface are recognized, wherein a button is each assigned to at least several contact points.

23. Method according to claim 22, wherein the several simultaneous touches are by several fingers.

24. Method according to claim 21, wherein the function(s) is or are displayed on an output screen spatially separated from at least one of the touch-sensitive surface and the vehicle component.

25. Method according to claim 21, wherein at least one of a haptic and optical feedback occurs when actuating the button or one of the buttons.

26. Method according to claim 21, wherein at least one of the position and the function of the button or the buttons are displayed by at least one optical element on the touch-sensitive surface.

27. Method according to claim 21, wherein it is recognized with which finger the touch-sensitive surface is touched and the corresponding finger of a hand is then allocated to the contact point.

28. Method according to claim 27, wherein the button that is b assigned to the contact point of a predetermined finger always has the same function.

29. Method according to claim 28, wherein the predetermined finger is the thumb.

30. Method according to claim 27, wherein it is recognized whether the finger of a left or a right hand touches the touch-sensitive surface, wherein at least one function is allocated depending on whether the touch-sensitive surface is operated by a right or a left hand.

31. Method according claim 21, wherein the function assigned to the button is preselected or the functions assigned to the buttons are preselected by the user.

32. Method according claim 31, wherein the function assigned to the button is preselected by at least one of a voice control, a gesture control and a mechanical input element spatially separated from the touch-sensitive surface.

33. Human machine interface for a vehicle, comprising a vehicle component, a control unit and a touch-sensitive surface that is provided on the vehicle component,
wherein during operation of the human machine interface, at least one button is provided on the touch-sensitive surface, the position of said button being determined by the control unit in such a way that, in the case of a touch of the touch-sensitive surface on an arbitrary contact point, the position of the button is set to the contact point that has been touched by the control unit.

34. Human machine interface according to claim 33, wherein several buttons can be provided at the same time in the case of several touches on several contact points, wherein each button is located at each one of the contact points that have been touched.

35. Human machine interface according to claim 33, wherein the human machine interface comprises an output screen that is located spatially separated from at least one of the touch-sensitive surface and the vehicle component, wherein the function of said at least one button is displayed on the output screen.

36. Human machine interface according to claim 33, wherein said at least one button is operable by means of at least one of renewed touch, increasing the pressure and shifting the contact point.

37. Human machine interface according to claim 13, characterized in that at least one of the touch-sensitive surface and the vehicle component comprises a mechanical feedback element for haptic feedback.

38. Human machine interface according to claim 37, characterized in that the mechanical feedback element is at least one of a vibration motor, a pressure resistance device and an ultrasonic source.

39. Human machine interface according to claim 33, characterized in that at least one optical element is provided on the touch-sensitive surface for displaying at least one of the position and function of said at least one button.

40. Human machine interface according to claim 13, characterized in that the vehicle component is at least one of a steering wheel, a seat, a control stick, a door trim, an armrest, a part of a center console, a part of a dashboard and a part of an overhead trim.
